(19) United States
(12) Patent Application Publication
(10) Pub. No.: US 2004/0266529 A1
(43) Pub. Date: Dec. 30, 2004

(54) Methods and systems for remote execution of game content and presentation on a wireless portable device

(75) Inventor: Masayuki Chatani, Foster City, CA (US)

Correspondence Address: MARTINE & PENILLA, LLP, 710 LAKEWAY DRIVE, SUITE 170, SUNNYVALE, CA, 94085, US

(73) Assignee: Sony Computer Entertainment America Inc., Foster City, CA

(21) Appl. No.: 10/611,141

(22) Filed: Jun. 30, 2003

(51) Int. Cl. A63F 13/00

(52) U.S. Cl. 463/40

(57) ABSTRACT

A system, a method, and a portable game device for playing a video game is provided. The system includes a first computing device for executing a video game. The execution of the video game is designed to produce processed interactive program instructions. A second computing device that is portable is provided. A wireless communication link capable of being established between the first computing device and the second computing device is included, wherein portions of the processed interactive program instructions are communicated to the second computing device to interactively play the video game at the second computing device location.

### BACKGROUND OF THE INVENTION

1. Field of the Invention

This invention relates generally to computer video games, and more particularly to portable video game devices, and methods for rendering rich game graphics on portable video game devices that can be wirelessly connected to a content execution server.

2. Description of the Related Art

The video game industry has seen many changes over the years. As computing power has expanded over recent years, developers of video games have likewise created game software that takes advantage of these increases in computing power. To this end, video game developers have been coding games that incorporate sophisticated operations and mathematics to produce a very realistic game experience.

Although computer code complexity and processing requirements are substantial to enable fast rendering of these realistic video games, such games are produced for particular target platforms. Such target platforms, for example, may be the Sony Playstation or Sony Playstation2 (PS2), each of which is sold in the form of a game console. As is well known, the game console is designed to connect to a monitor (usually a television) and enable user interaction through handheld controllers. The game console is designed with specialized processing hardware, including a CPU, a graphics synthesizer for processing intensive graphics operations, a vector unit for performing geometry transformations, and other glue hardware, firmware, and software. The game console is further designed with an optical disc tray for receiving game compact discs for local play through the game console. Online gaming is also possible, where a user can interactively play against or with another user through the Internet. In either case, however, the video game code is executed and rendered on the local game console.

Another form of video game playing is through a portable game device. Portable game devices have been available for some time. Recently, some companies have been developing portable game devices that resemble mini-laptops. Although these portable game devices provide good processing power to render decent quality games, the processing power is not as sophisticated or as powerful as a full scale game console. This limitation is in part due to economics and in part due to portability. Firstly, if the portable device is equipped with extra processing power, the hardware, firmware, and integration will make the device unaffordable to the common game user. And secondly, by definition, if the game device is too large and includes all of the processing power of a home game console, then the device will no longer be very portable. For these reasons, current portable game devices are not able to provide as rich of a gaming experience as does a home game console.

In view of the foregoing, there is a need for a portable game device that is small enough to truly be portable, is capable of providing rich interactive content, and is reasonably priced.

### SUMMARY OF THE INVENTION

Broadly speaking, the present invention fills these needs by providing a system, a method, and a portable game device. The method of the system and portable game devices enables execution of a video game at a base computing device and wirelessly communicates processed data to a portable game device.

In one embodiment, a system for playing a video game is provided. The system includes a first computing device for executing a video game. The execution of the video game is designed to produce processed interactive program instructions. A second computing device that is portable is provided. A wireless communication link capable of being established between the first computing device and the second computing device is included, wherein portions of the processed interactive program instructions are communicated to the second computing device to interactively play the video game at the second computing device location.

In another embodiment, a method for rendering video game content on a portable game device is provided. The method includes providing a content execution server that is capable of processing interactive program instructions of a video game. The method further includes communicating the processed interactive program instructions of the video game over a wireless communication link and receiving the processed interactive program instructions at a portable game device. The portable game device is capable of generating video, audio, and control data to display graphics on a display of the portable game device and output sound on a speaker of the portable game device.

In still another embodiment, a system for enabling remote wireless video game execution and play is provided. The system includes a base computing device for executing a video game, and the execution of the video game is designed to produce processed interactive program instructions. A portable game device having at least a processor, memory, and a display is included. Further included is a wireless communication link that is capable of being established between the base computing device and the portable game device. Portions of the processed interactive program instructions are communicated to the memory and processor for presentation on the display, and additional portions of the processed interactive program instructions are received at the memory as play of the video game proceeds.

In another embodiment, a system for playing a video game on a portable game device is provided. The system includes a base computing device for executing a video game to produce processed interactive program instructions. A portable game device is included in the system. A wireless communication link is provided and is capable of being established between the base computing device and the portable game device. Portions of the processed interactive program instructions are communicated to the portable game device to interactively play the video game at the portable game device.

In still anther embodiment, a portable device for interacting with video game content is disclosed. The portable device includes a processor, memory, and an input/output interface. The input/output interface is capable of wirelessly connecting to a content execution server, and the content execution server is capable of processing interactive program instructions of a video game. The memory is configured to receive processed interactive program instructions of the video game and the processor is configured to execute the processed interactive program instructions to enable interaction with the video game content on the portable device.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIGS. 1A-1C illustrate exemplary wireless portable devices being in communication with a content execution server, in accordance with one embodiment of the present invention.

FIGS. 2A-2B illustrate an example portable game device and hardware, in accordance with one embodiment of the present invention.

FIGS. 3A-3C illustrate communication between the content execution server and the portable game device, in accordance with one embodiment of the present invention.

FIGS. 4A-4B illustrate example communication connections for a portable game device and servers, in accordance with one embodiment of the present invention.

FIGS. 5-7 illustrate flow charts defining exemplary process interaction between a portable game device and a content execution server, in accordance with one embodiment of the present invention.

### DETAILED DESCRIPTION OF THE PREFERRED EMBODIMENTS

An invention is disclosed for a method and system for enabling portable game devices to present a rich graphic user experience, while connected to a base computing device. In one embodiment, the base computing device is a server emulating a game system, or a game system. The base computing device is configured to execute a game program and communicate or stream executed game instructions to a portable game device. The executed game instructions can be communicated to the portable game device through a network. Example networks may be the Internet, a local Intranet using a WiFi interface (e.g., 802.11x Standard wireless connection) or the like. The portable game device is therefore configured to be wirelessly connected to the base computing device, which is charged with performing the necessary processing commonly performed on a game console.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to obscure the present invention.

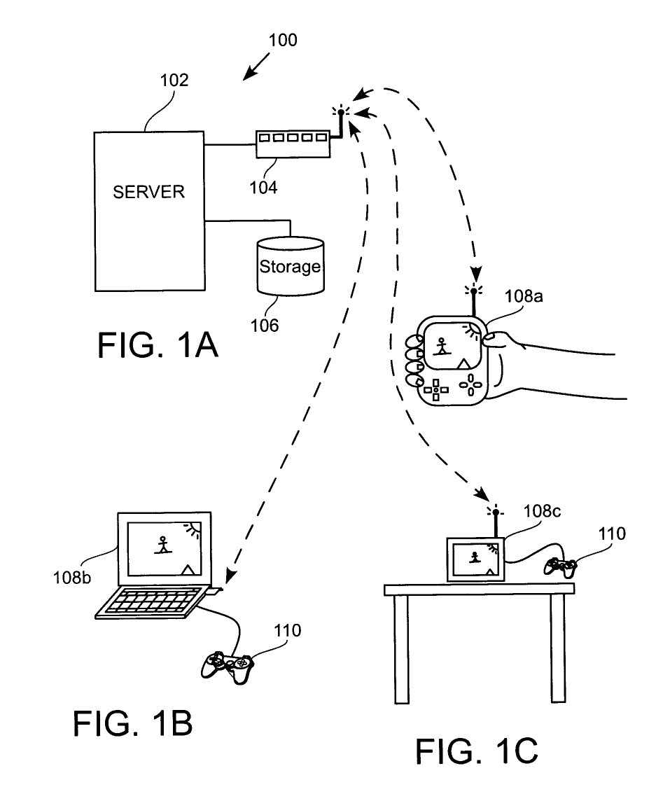

FIG. 1A illustrates a game playing system 100 in accordance with one embodiment of the present invention. The game playing system 100 includes a content execution server 102 that is coupled to storage 106, and a wireless transceiver 104. The wireless transceiver 104, although shown external to the content execution server 102, can be integrated into the content execution server 102. Preferably, the wireless transceiver 104 is a WiFi transceiver that is capable of communicating with local wireless devices at high speeds.

In one embodiment, the wireless transceiver 104 is capable of being in communication with a portable game device 108a. The portable game device 108a, is preferably a light-weight device that is capable of receiving processed game instructions from the content execution server 102, and then quickly render them at the portable game device 108a. In this example, the portable game device 108a is designed to receive processed interactive program instructions from the content execution server 102. The content execution server 102 will preferably include game system emulation software that is executed at the content execution server 102 and is used to emulate the processing performed by a typical game console.

In this manner, the content execution server 102 will act as a base computing device that will execute program instructions of the game and then transmit via the wireless transceiver 104, processed active program instructions to the portable game device 108a. By pre-processing the game instructions at the content execution server 102, it is possible to provide the portable game device 108a with a minimal amount of hardware to process complex software that typically defines modern game programs.

FIGS. 1B and 1C illustrate additional examples in which a laptop 108b, or a game device 108c can communicate with the content execution server 102 via the wireless transceiver 104. In each case shown in FIGS. 1B and 1C, the processing of the game program is primarily done at the content execution server 102, and the receiving devices, such as the laptop 108b and the game device 108c, will merely perform higher level processing on the received instructions which have been previously processed. In this manner, the receiving device can concentrate on providing video display and providing audio output to the user, and exchanging control data that is defined by the interactive user input. In the examples of FIGS. 1B and 1C, a user control 110 can also be used to interface with each of the laptop 108b, or the game device 108c. In either case, the receiving devices will not be required to have robust processing circuitry which is commonly required to execute typical game programs that involve sophisticated mathematical operations, lighting adjustments, and graphics.

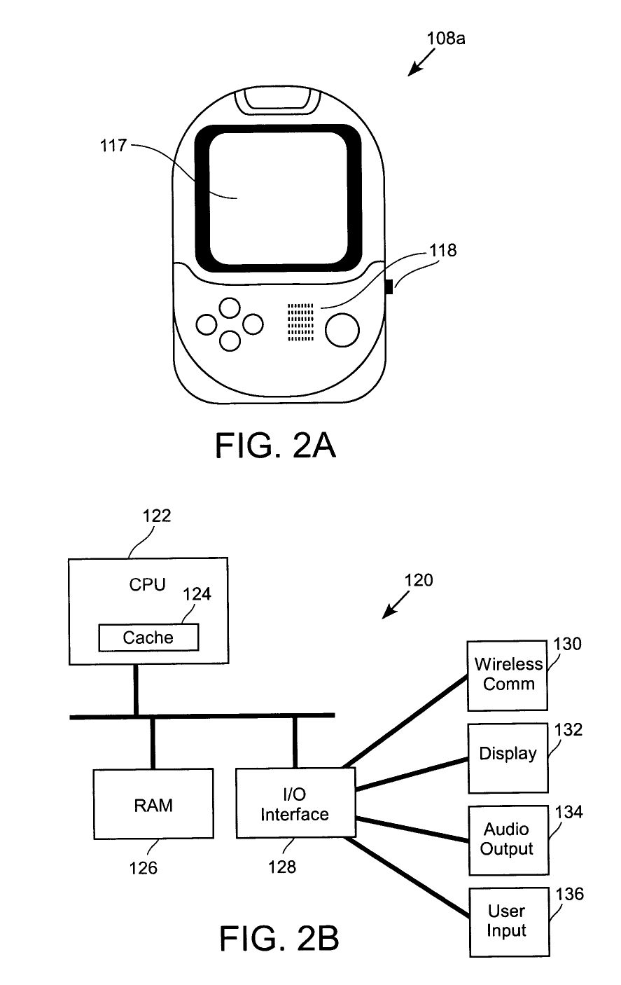

FIG. 2A illustrates, in more detail, a portable game device 108a having a display 117, and speaker outputs 118. In one example, the portable game device will include an integrated speaker and/or a speaker jack.

FIG. 2B illustrates system components 120 of a typical portable game device 108a. In this example, a central processing unit (CPU) 122, is provided. The CPU 122 may also, in one embodiment, include cache 124, for storing program instructions that will be processed by the CPU 122 in a more immediate basis. RAM 126 is also optionally provided in case the cache 124 is not sufficiently large enough to hold data being received or streamed from the content execution server 102 during play. An I/O interface 128 is provided to interface with the modules of the portable game device 108a. As shown, the I/O interface 128 will be coupled to a wireless communication device 130, a display 132, an audio output 134, and a user input 136.

As mentioned above, the wireless communication device 130 is preferably a transceiver that is capable of high speed communication with a complementary wireless transceiver. An example of the wireless communication device 130 may be a WiFi device that is capable of communicating data at high speeds in the range of local Ethernet LAN networks. In a preferred embodiment, the wireless communication device 130 will preferably communicate at a speed that is sufficiently high, to provide the cache 124 of the CPU 122 with sufficient data for processing to render the video game on the display 117 of the portable game device 108a.

Consequently, the communication link provided by the wireless communication device 130 will be sufficient to provide successive portions of the processed interactive programmed instructions to the cache 124, and the RAM 126, if additional data is received and not processed by the CPU 122. As the CPU 122 processes data received from the content execution server 102, the cache 124 is replenished either from the content execution server 102 or the RAM 126.

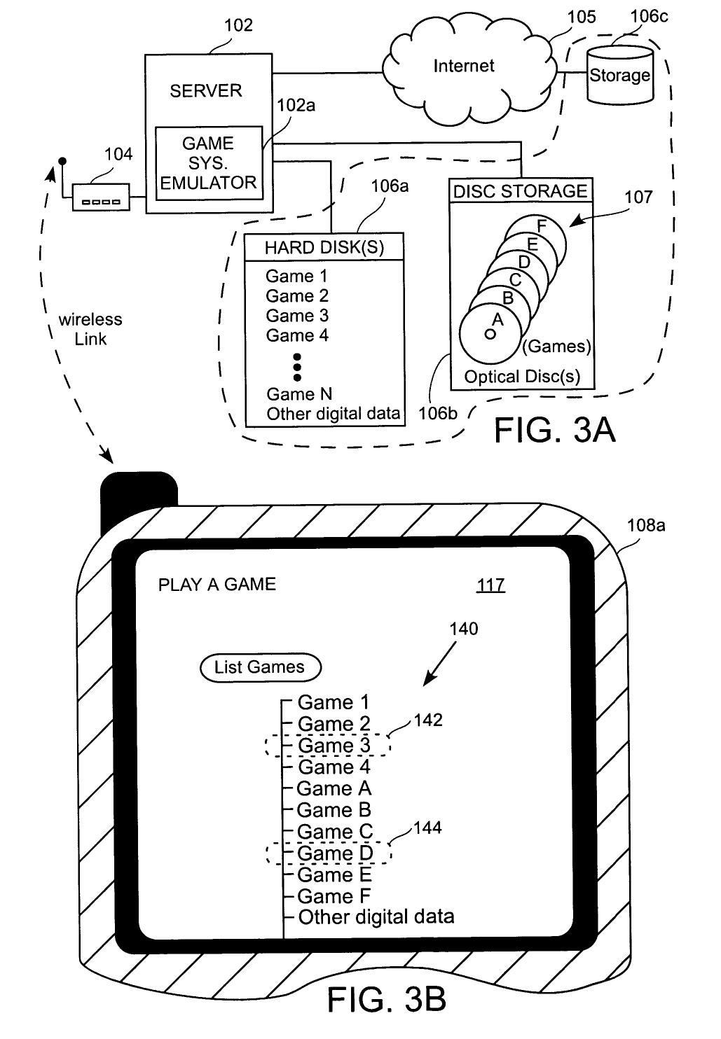

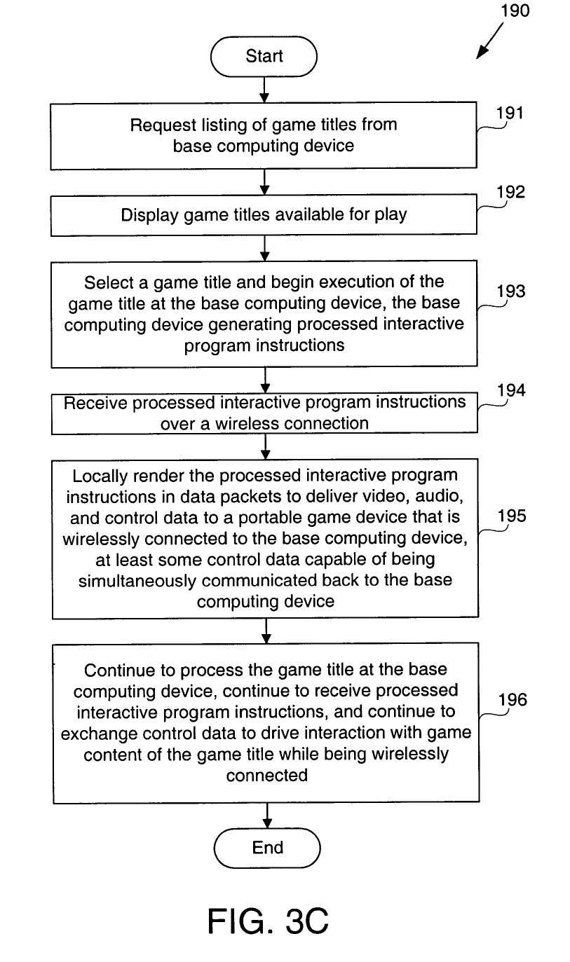

FIG. 3B shows a more detailed diagram of the content execution server 102 being in communication with the portable game device 108a. As shown, the content execution server 102 is in communication with the portable game device 108a, via a wireless link facilitated by wireless transceiver 104 connected to the server 102, and a transceiver integrated into the portable game device 108a.

In one embodiment, the content execution server 102 will include a game system emulator 102a. The game system emulator 102a can take on a number of forms. In one example, the game system emulator 102a can be software that emulates the processing performed by a game console and its respective hardware, software and firmware. When emulation is performed in software, the content execution server 102 processor(s) must be sufficiently powerful to emulate the processing performed by the hardware, software, and firmware of a game console.

The game system emulator 102a can also take the form of hardware and firmware. When the game system emulator 102a takes the form of hardware, similar hardware components present in a game console, would be integrated onto a printed circuit board and placed in communication with other circuitry of the content execution server 102.

As is well known, a game console will include a CPU, a graphics processor, memory, and specialized circuitry for handling graphics computations. In this example, the content execution server 102 is shown connected to storage 106. Storage 106 can take on any number of forms, as shown in FIG. 3A. One example is for the content execution server 102 to be directly coupled to hard disk drives 106a. When hard disk drives are used, a number of games can be stored on the hard disks, in a similar way that games are stored on compact discs.

The games will then be itemized and stored for retrieval/execution at a later time by a user. In addition to games, it should be understood that the data being held by the content execution server 102 may also include other digital data. Examples of other digital data may include, but not limited to, movies, DVD data, music, or other entertainment or business digital content. The storage 106 can also be in the form of disc storage 106b. In such a storage arrangement, the storage may be in the form of a jukebox that includes a number of optical discs 107, shown as discs A through F.

Finally, the storage 106 can also be coupled to the content execution server 102 over the Internet 105, or local network. Accordingly, the storage 106 can take on any form (stored locally or remotely), so long as the content execution server 102 can access the data for the games or digital content, and suitably execute using the game system emulator 102a.

FIG. 3B illustrates a portable game device 108a with a display 117 providing the user with media content 140. The media content 140 is shown as a plurality of games and other digital data. In one embodiment, the portable game device 108a will have software capable of making a request to the content execution server 102 for a list of games that may be available to the user of the portable game device 108a. In this example, the user may be provided with a list of available games shown as games 1 through 4, and games A through F, and other digital data. However, the user may not be provided access to certain games if the user does not have a legal copy or a license to use the particular game. Such security processing is preferably conducted at the content execution server 102.

In this example, game 3 142 and game D 144 are games that are not accessible currently to the user. In one embodiment, the user may be provided with a user interface to purchase the games 142 and 144 for use through the portable game device 108a. In another embodiment, the user may be provided with a list of games that could be rented for a number of plays. In such a case, the user would be provided with a list of games that can be purchased for a different monetary denomination, depending on the number of games desired for play.

A process for monitoring the number of plays would then be used to provide the user with only those accesses that are pre-paid. Once the user selects the game he or she desires to use, the selection is made and the server, using the game system emulator 102a, will begin to process the game and transmit the game, and transmit pre-processed interactive program instructions to the portable game device in portions, depending on which portion of the processed interactive game instructions are needed to render the action associated with the video game.

FIG. 3C illustrates a flowchart 190 that defines communication interaction between a base computing device and a portable game device, in accordance with one embodiment of the present invention. The method begins at operation 191 where a request to list the game titles available at the base computing device is provided from a portable game device.

As discussed above, the base computing device has access to storage which may have one or more games available to a requesting portable game device or devices. The method moves to operation 192 where game titles available for play are displayed to the user. As shown in FIG. 3B, the game titles may be provided in a list, in the form of graphical user icons for a particular game, or the like. In either case, the user is able to ascertain what games are available for play from the base computing device. The method then moves to operation 193 where a game title is selected by the user to begin execution of the game title at the base computing device. The base computing device being configured to generate processed interactive program instructions from the program instructions that define the game title.

As used herein, processed interactive game instructions define the resulting data that would have been output by a local typical game console to a user by way of a display screen, speakers, and user feedback. However, instead of outputting the processed interactive programs instructions locally, they are transmitted in packets to the target portable game device 108a. The method then moves to operation 194 where the processed interactive program instructions are received over a wireless connection at the portable game device.

In operation 195, the processed interactive program instructions are locally rendered on the portable game device to deliver the video data that will be displayed, the audio data that will be communicated to the user, and the control data that is or may be output by the portable game device. In one embodiment, at least some control data is capable of being simultaneously communicated back to the base computing device to interact with the action of the video game.

The method now moves to operation 196 where the game title will continue to be processed at the base computing device, the portable game device will continue to receive processed interactive program instructions, and the exchange of control data between the base station and the portable device will continue to drive interaction with the game content of the game title, while being wirelessly connected. At this point, the method will end.

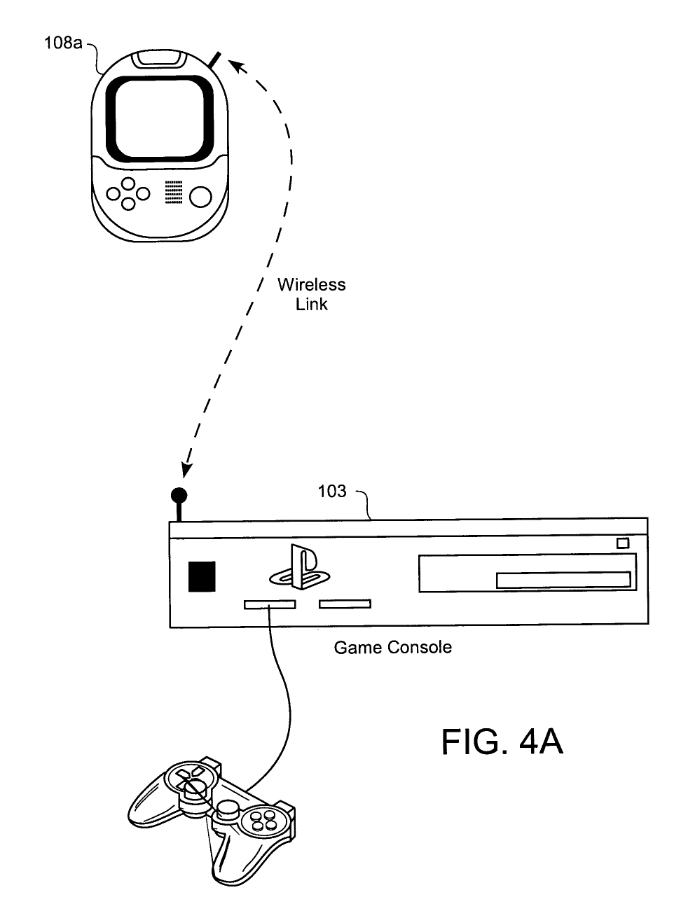

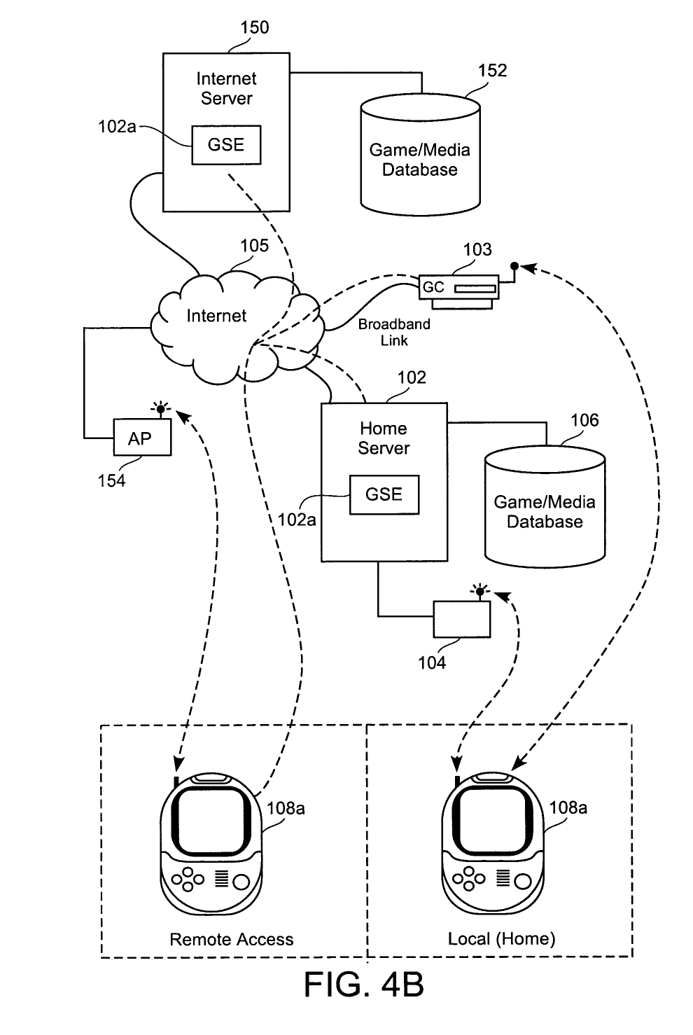

FIG. 4A illustrates an example where the game console 103 itself will include a transceiver for establishing the wireless connection with the portable game device 108a. In this manner, a user of a video game can insert the game CD into their game console 103, begin execution of the video game at the game console 103, and then play the game remotely through their wireless link. Advantageously, the user will not be required to remain in front of the game console 103 during play, and may roam around an area that will be sufficiently close to maintain the wireless link.

FIG. 4B illustrates another embodiment where an Internet server 150 may include a game system emulator 102a. As discussed above, the game system emulator 102a is designed to emulate the hardware and software that defines a game console 103. The Internet server 150, in this embodiment, will be coupled to storage that includes a game/media database 152. The game and media database 152 may be a collection of games and/or media that can be made available to a user of a portable game device 108a. For instance, a user of the portable game device 108a may communicate with the Internet server 150 and purchase through an e-commerce transaction, a number of games to use over the Internet.

In this manner, the game user will not necessarily be provided with a compact disc of the game, but will always have access to the game by way of the Internet that has access to the Internet server 150, and the game/media database 152. In this example, remote access can be accomplished through an access point 154 that defines a hot spot. As is well known, hot spots are defined by access points that enable users close enough to the access point 154 to access the Internet.

In today's wired world, many users are able to access hot spots free of charge in many locations such as coffee houses, airports, gas stations, and the like. Once the user is close enough to the access point, the user can log into the Internet server 150 and use their previously purchased games, or purchase new games for entertainment. In another embodiment, the remote access user can access their own video games that are stored on their home system, such as the content execution server 102 or a game CD loaded into a game console 103.

In another embodiment, the local home user will be able to access their home server 102 to gain access to their games or media database that includes games that were previously purchased, or access a game that is currently being executed or to be executed on the game console 103. In each case, main processing of the video game program will occur at a location that is remote from the portable game device 108a. In this manner, the user of the portable game device 108a will have a rich content experience without having to purchase expensive hardware that may be bulky or consume an unnecessary amount of battery power.

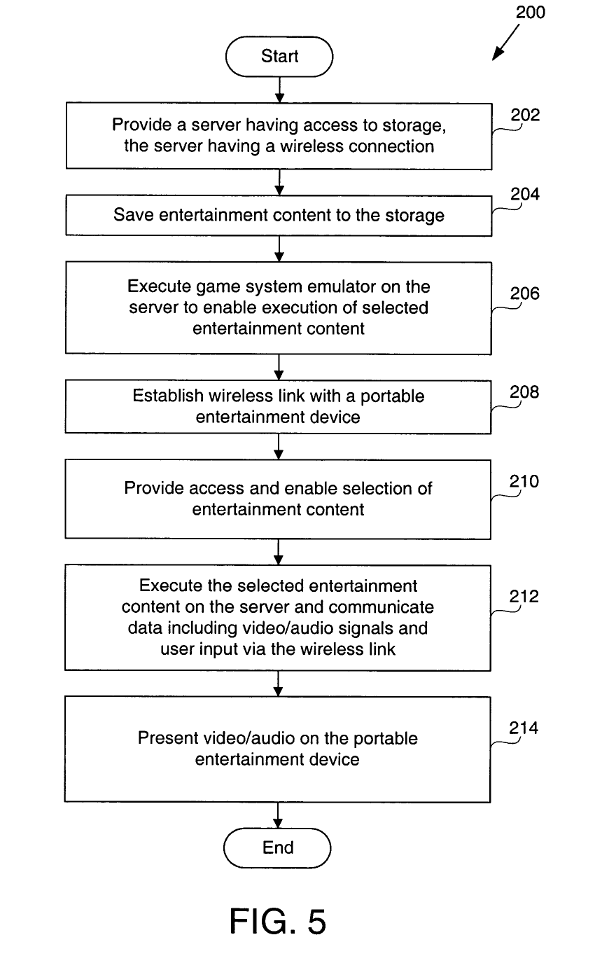

FIG. 5 illustrates a flowchart 200 defining method operations capable of being performed when a server executes game program instructions and communicates them to a portable gaming device over a wireless link, in accordance with one embodiment of the present invention. The method begins at an operation 202 where a server having access to storage is provided. The server will preferably have a wireless connection for transmitting wireless signals to devices wishing to connect to the server. The method then proceeds to operation 204 where entertainment content is saved to the storage.

The entertainment content may be in the form of game files that are stored to hard disks, or other storage, or games that are stored on optical discs. The method then moves to operation 206 where a game system emulator is executed on the server to enable execution of selected entertainment content. The game system emulator, as mentioned above, is preferably either software, hardware, or a combination of software and hardware that is capable of emulating the processing performed by a game console. The processing and components of a game console are well know to those skilled in the art. In still another embodiment, the game system emulator may be omitted if the server is in the form of a game console that already integrates the necessary hardware and software to process game software.

The method moves to operation 208 where a wireless link is established with a portable entertainment device. As mentioned above, the portable entertainment device may be in the form of a portable game unit, a laptop, a PDA, a cell phone, a computer tablet, or the like. Access is then provided to enable selection of particular entertainment content stored on the storage of the server in operation 210. In operation 212, selected entertainment content is executed on the server and executed content is communicated in data packets which may include video/audio signals, and user input. The data packets may communicate the video, audio, and user input exchange in any format, so long as the receiving portable device limits its raw processing which is being performed by the server unit.

The method now moves to operation 214 where the video/audio of the game being played is presented on the portable entertainment device. To continue presenting the video game content on the portable entertainment device, the server will continue to stream processed data packets to the portable device to maintain a continuous and seamless game play experience.

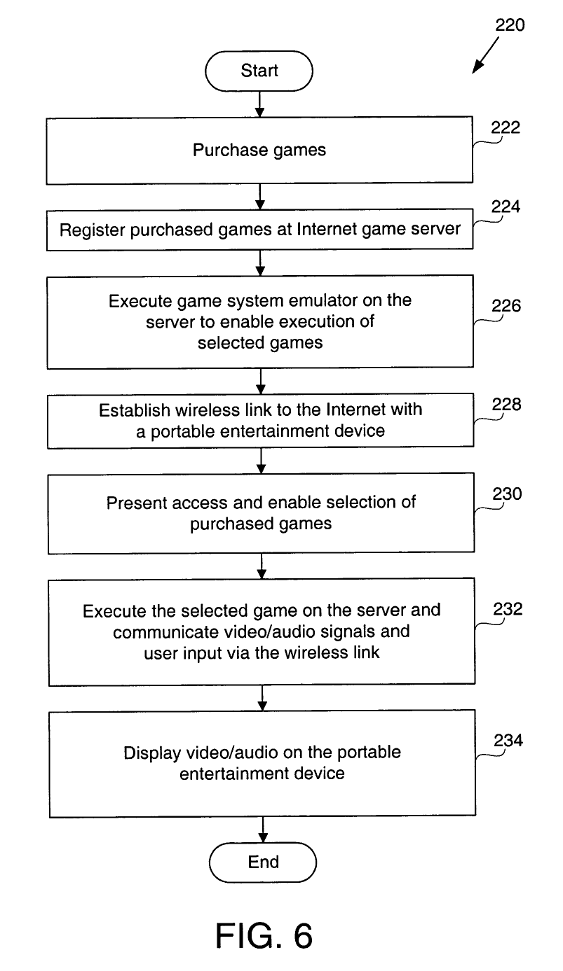

FIG. 6 illustrates another flowchart 220, where a user may purchase games to enable future use of such games over the Internet through a game server. The method begins at operation 222 where a user may purchase games through the Internet for later use or immediate use. The method then moves to operation 224 where the purchased games are registered at the Internet game server. If a game is purchased, from a store and not through the Internet, the user may then be able to log in to the Internet game server and register the previously purchased game. In this manner, the user will be allowed to access the same purchased game over the Internet from the Internet game server.

In operation 226, a game system emulator is executed on the server to enable execution of selected games. In the case of an Internet server that is providing access to multiple users, the Internet server should be capable of processing multiple games through a number of system emulators. The method then moves to operation 228 where a wireless link is established to the Internet with a portable entertainment device. The user will then be provided with access in operation 230 to enable selection of the previously purchased games or purchase games on the spot. In operation 232, the selected game would then be executed on the server and the executed game would be communicated in the form of data holding video and audio signals and user input, via the wireless link. At the portable entertainment device, the video/audio is presented on the portable entertainment device to allow the user to interact with the video game.

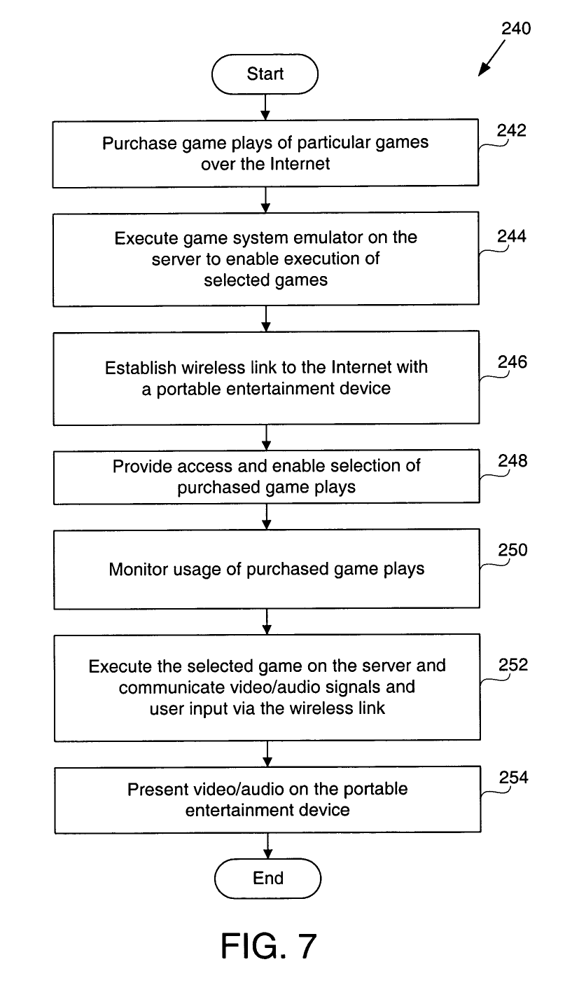

FIG. 7 shows a flowchart 240 defining a method for monitoring usage of purchased games to be provided by a server that allows access to games over the Internet to wireless devices. The method begins at operation 242 where game plays of particular games are purchased over the Internet. In one embodiment, a server may provide access to a library of games and a user may register to purchase X number of game plays of particular games. The method then moves to operation 244 where a game system emulator is executed on the server to enable execution of selected games.

The method then moves to operation 246 where a wireless link is established to the Internet with a portable entertainment device. As mentioned above, the portable entertainment device may access the Internet through an access point (e.g., hot spot), and gain access to its server that provides game access. The method then moves to operation 248 where access is provided to enable selection of particular purchased game plays. For instance, a user may have purchased ten game plays in the past, and used three game plays. As such, the user would have seven game plays left and usage of the purchased game plays would be monitored in operation 250.

In operation 252, the selected game is executed on the server, and the data representing processed game instructions, are communicated to define video and audio signals on the portable entertainment device. User input signals are also exchanged between the server and the portable entertainment device to interactively use the game during a gaming session. In operation 254, the video and audio data that is representative of the video game play is presented on the portable entertainment device, and processed data is continually streamed to the portable entertainment device to provide seamless interactive game play.

One example of a wireless communication link, as mentioned above, is a WiFi connection, as defined by the Institute of Electrical and Electronics Engineers (IEEE) 802.11x. The notation “x” is used because the 802.11 protocol has many revisions, and the specific revision is not important, so long as fast enough communication can be had. Other communication links may include, for shorter distances, communication using Bluetooth. In addition, as communication protocols currently used in cell phones increases in bandwidth, such communication protocols will be seen just as applicable as today's WiFi technology.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for rendering video game content on a portable game device, comprising:
providing a content execution server, the content execution server capable of processing interactive program instructions of a video game;
communicating the processed interactive program instructions of the video game over a wireless communication link; and
receiving the processed interactive program instructions at a portable game device, the portable game device being capable of generating video, audio, and control data to display graphics on a display of the portable game device and output sound on a speaker of the portable game device.

2. A method for rendering video game content on a portable game device as recited in claim 1, wherein processed interactive program instructions include data for providing the video, audio and control data.

3. A method for rendering video game content on a portable game device as recited in claim 2, wherein the control data is exchanged between the portable game device and the content execution server, the exchange of the control data configured to at least partially drive user interactivity.

4. A method for rendering video game content on a portable game device as recited in claim 1, wherein program code for the interactive program instructions of the video game is primarily stored and executed on the content execution server.

5. A method for rendering video game content on a portable game device as recited in claim 4, wherein the content execution server includes a game system emulator, the game system emulator being configured to simulate processing by game console hardware and software.

6. A method for rendering video game content on a portable game device as recited in claim 5, wherein the game system emulator is one of software, hardware, software-hardware, and software-hardware-firmware.

7. A method for rendering video game content on a portable game device as recited in claim 3, wherein the wireless communication link is bi-directional to enable the exchange of the control data during game play.

8. A method for rendering video game content on a portable game device as recited in claim 1, wherein the portable game device is a handheld device.

9. A method for rendering video game content on a portable game device as recited in claim 1, wherein communicating of the processed interactive program instructions of the video game over the wireless communication link occurs in portions, each portion being communicated to the portable game device to prevent stoppage in play of the video game.

10. A method for rendering video game content on a portable game device as recited in claim 9, wherein each portion is stored in a buffer of the portable game device before rendering, the buffer being maintained at a minimum level to prevent the stoppage in play.

11. A method for rendering video game content on a portable game device as recited in claim 1, wherein the portable game device includes a processor, memory for holding the received processed interactive program instructions and an I/O interface.

12. A system for enabling remote wireless video game execution and play, comprising:
a base computing device for executing a video game, the execution of the video game designed to produce processed interactive program instructions;
a portable game device having at least a processor, memory, and a display; and
a wireless communication link capable of being established between the base computing device and the portable game device, wherein portions of the processed interactive program instructions are communicated to the memory and processor for presentation on the display, and additional portions of the processed interactive program instructions being received at the memory as play of the video game proceeds.

13. A system for enabling remote wireless video game execution and play as recited in claim 12, wherein the portable game device is capable of exchanging control data with the base computing device during play of the video game to enable interaction with the video game.

14. A system for enabling remote wireless video game execution and play as recited in claim 13, wherein the base computing device is one of a content execution server, an Internet server, and a game console.

15. A system for enabling remote wireless video game execution and play as recited in claim 14, wherein the content execution server and the Internet server include a game system emulator.

16. A system for enabling remote wireless video game execution and play as recited in claim 15, wherein the game system emulator in the form of one of software, hardware, software-hardware, and software-hardware-firmware.

17. A system for enabling remote wireless video game execution and play as recited in claim 12, wherein the base computing device has access to a plurality of games from storage connected to the base computing device.

18. A system for playing a video game on a portable game device, comprising:
a base computing device for executing a video game, the execution of the video game designed to produce processed interactive program instructions;
a portable game device; and
a wireless communication link capable of being established between the base computing device and the portable game device, wherein portions of the processed interactive program instructions are communicated to the portable game device to interactively play the video game at the portable game device.

19. A system for playing a video game on a portable game device as recited in claim 18, wherein the portable game device includes at least a processor, memory, and a display.

20. A system for playing a video game on a portable game device as recited in claim 19, wherein portions of the processed interactive program instructions are communicated to the memory and processor for presentation on the display, and additional portions of the processed interactive program instructions being received at the memory as play of the video game proceeds.

21. A system for playing a video game on a portable game device as recited in claim 18, wherein the portable game device is capable of exchanging control data with the base computing device during play of the video game to enable interaction with the video game.

22. A system for playing a video game on a portable game device as recited in claim 18, wherein the base computing device is one of a content execution server, an Internet server, and a game console.

23. A system for playing a video game on a portable game device as recited in claim 22, wherein the content execution server and the Internet server include a game system emulator.

24. A system for playing a video game on a portable game device as recited in claim 23, wherein the game system emulator in the form of one of software, hardware, software-hardware, and software-hardware-firmware.

25. A system for playing a video game on a portable game device as recited in claim 18, wherein the base computing device has access to a plurality of games from storage connected to the base computing device.

26. A system for playing a video game on a portable game device as recited in claim 18, wherein the wireless communication link a WiFi link.

27. A system for playing a video game, comprising:
a first computing means for executing a video game, the execution of the video game designed to produce processed interactive program instructions;
a second computing means being portable; and
a wireless communication link capable of being established between the first computing means and the second computing means, wherein portions of the processed interactive program instructions are communicated to the second computing means to interactively play the video game at the second computing means.

28. A system for playing a video game as recited in claim 27, wherein the second computing means includes at least a processor, memory, and a display.

29. A system for playing a video game as recited in claim 28, wherein portions of the processed interactive program instructions are communicated to the memory and processor for presentation on the display, and additional portions of the processed interactive program instructions being received at the memory as play of the video game proceeds.

30. A system for playing a video game as recited in claim 28, wherein the second computing means is capable of exchanging control data with the first computing means during play of the video game to enable interaction with the video game.

31. A portable device for interacting with video game content, the portable device comprising:
a processor;
memory; and
an input/output interface, the input/output interface being capable of wirelessly connecting to a content execution server, the content execution server capable of processing interactive program instructions of a video game, the memory configured to receive processed interactive program instructions of the video game and the processor configured to execute the processed interactive program instructions to enable interaction with the video game content on the portable device.

32. A portable device for interacting with video game content as recited in claim 31, wherein the input/output interface includes a wireless communication device for enabling wireless connection with the content execution server.

33. A portable device for interacting with video game content as recited in claim 32, wherein the input/output interface connects to a user input, an audio output, and a display.

34. A portable device for interacting with video game content as recited in claim 31, wherein execution of the processed interactive program instructions is capable of generating video, audio, and control data to display graphics on a display of the portable game device and output sound on a speaker of the portable game device.

35. A portable device for interacting with video game content as recited in claim 34, wherein the control data is exchanged between the portable game device and the content execution server, the exchange of the control data is configured to at least partially drive user interactivity.

36. A portable device for interacting with video game content as recited in claim 31, wherein program code for the interactive program instructions of the video game is primarily stored and executed on the content execution server.
